(19) United States
(12) Patent Application Publication
(10) Pub. No.: US 2008/0046223 A1
(43) Pub. Date: Feb. 21, 2008

(54) METHOD OF OPTIMIZING ENHANCED RECOVERY OF A FLUID IN PLACE IN A POROUS MEDIUM BY FRONT TRACKING

(76) Inventors: BENOIT NOETINGER, Paris (FR); PAVEL SPESIVTSEV, Rueil-Malmaison (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/838,919

(22) Filed: Aug. 15, 2007

(30) Foreign Application Priority Data
Aug. 16, 2006 (FR) 06/07.374

(51) Int. Cl. G06G 7/48

(52) U.S. Cl. 703/9

(57) ABSTRACT

The method optimizes the development of a heterogeneous porous medium within the context of enhanced recovery of a fluid in place, by fast determination of the position of the front separating a sweeping fluid and the fluid in places having application for development of oil reservoirs or gas. The velocity field in the neighbourhood of the front is determined only once by means of a flow simulator. Then a relation describing the position of the front in the heterogeneous medium is defined by freedom from the viscous coupling by means of the perturbation theory, and by accounting for the velocity fluctuations in the front advance direction and the velocity fluctuations in the direction perpendicular to the front advance direction. Finally, for each time interval, the position of the front is reconstructed by means of a fast Fourier transform and injection of the sweeping fluid is optimized according to the position of said front.

### FIELD OF THE INVENTION

The present invention relates to a method for optimizing the development of a heterogeneous porous medium within the context of enhanced recovery of a fluid in place, by determining the position of the front separating a sweeping fluid and the fluid in place.

In particular, the method according to the invention allows to determine the position of a front separating two immiscible fluids in motion, without systematically updating the pressure field, so as to obtain a simulation of the multiphase flows in the porous medium that is fast and accurate enough to allow to obtain quantitative information for optimum development of the medium.

The method finds applications notably for the development of oil or gas reservoirs, or the development of underground gas storage for example.

### BACKGROUND OF THE INVENTION

All the notations used to describe the prior art and the invention are defined at the end of the description.

To know how to describe and simulate multiphase flows in underground reservoirs is at the root of reservoir engineers' skill in petroleum or gas companies (or, similarly, in water adduction companies). The presence of subsoil heterogeneities and the increasing complexity of drainage systems make a simple analytical solution impossible, which requires development of numerical solutions using a gridded model. The simulation of multiphase flows in a heterogeneous porous medium can then require considerable computing resources, in particular when the numerical model of the medium considered is greatly detailed. This is notably the case in reservoir engineering, in the petroleum sphere. This cost is mainly due to the solution of large-size linear systems from the equation that governs the pressure, which have to be updated by following the fluid displacement in order to reach a solution of good precision.

Within the context of a two-phase flow in a heterogeneous porous medium, one considers the displacement of a fluid in place (oil for example) under the effect of the injection of another fluid (water for example). The generalized Darcy's law that governs the motion of fluids is written as follows, by means of standard hypotheses and notations:

$$\begin{matrix}{u}_{nw} = - {λ}_{nw} ∇ {p}_{nw} , {λ}_{nw} = \frac{{Kk}_{rnw}}{{μ}_{nw}} & ( 1 ) \\ {u}_{w} = - {λ}_{w} ∇ {p}_{w} , {λ}_{nw} = \frac{{Kk}_{rw}}{{μ}_{w}} & ( 2 )\end{matrix}$$

u=u_{nw}+u_{w} (3)

where subscripts nw and w designate the nonwetting and wetting fluids respectively. The pressure difference between the two fluids is denoted by p_{c}(S)=p_{nw}−p_{w}. We have the relation:

S_{nw}+S_{w}=1 (4)

It is therefore possible to write all the functions depending on saturation S in terms of saturation S_{w}.

By disregarding the capillary pressure, we have:

p_{nw}=p_{w}=p (5)

The total velocity then takes the form as follows:

u=−λ(S_{w})∇p (6)

with:

∇.u=0 (7)

This system of equations (6) and (7) defines the pressure equation.

In equations (1) and (2), functions kᵣ are the relative permeabilities. We have kᵣ=kᵣ(S_{w}). Functions λ_{nw},λ_{w} are the respective mobilities of the fluids, and λ(S_{w})=λ_{nw}(S_{w})+λ_{w}(S_{w}) is the total mobility, which thus explicitly depends on S_{w}.

The mass conservation laws relative to each fluid are written as follows:

$$\begin{matrix}φ \frac{\partial {S}_{nw}}{\partial t} + ∇ \cdot {u}_{nw} = 0 & ( 8 ) \\ φ \frac{\partial {S}_{w}}{\partial t} + ∇ \cdot {u}_{w} = 0 & ( 9 )\end{matrix}$$

This system of equations (8) and (9) defines the saturation equation. Here, φ is the porosity (assumed to be uniform in the reservoir), t the time and u_{n,nw} is the velocity of the fluid considered.

One of the difficulties in solving these equations comes from the coupling between equations (6) to (9) that couple the saturation to the pressure field. These effects are well known and they control the development of possible viscous instabilities. In particular, in the 1D case, considering sweeping of an initially oil-saturated medium with water, this system of equations can be solved by means of the method of characteristics, whose solutions are characterized by the existence of oscillations corresponding to saturation jumps propagating in the medium.

The discontinuity is characterized by a water saturation changing from S_{wi} to S_{f}, the saturation at the front whose value is given by a Rankine-Hugoniot type condition. In the petroleum context, construction of the Welge tangent allows to determine S_{f} graphically. Behind this front, a “rarefaction wave” provides transition between S_{f} and the water saturation upon injection.

There are several known techniques for determining the simulation of multiphase flows in heterogeneous porous media. These methods are all based on the solution of the following system of equations:

$$\{ \begin{matrix}\begin{matrix}Pressure equation : \\ u = - λ ( {S}_{w} ) ∇ p\end{matrix} & ( 10 ) \\ \begin{matrix}∇ \cdot u = 0 \\ Saturation equation :\end{matrix} & ( 11 )\end{matrix} \\ \begin{matrix}φ \frac{\partial {S}_{nw}}{\partial t} + ∇ \cdot {u}_{nw} = 0 & ( 12 ) \\ φ \frac{\partial {S}_{w}}{\partial t} + ∇ \cdot {u}_{w} = 0 & ( 13 )\end{matrix}$$

The techniques differ in the method used for solving this system. Generally, in a complex heterogeneous medium, this type of system of equations has to be solved numerically.

Oil companies most often use conventional discretization techniques of finite volume type (Aziz, Kb., Settary, A.: Petroleum reservoir simulation. Applied science publishers, London, 1979). Concerning temporal discretization, there are many choices: if numerical robustness is favoured, one can be totally implicit in pressure as well as saturation. If oscillations of the solution are preferably avoided and higher accuracy is desired, an implicit scheme will be selected for pressure, and explicit for saturation. One generally observes the existence of fronts characterized by the same discontinuity of the saturation, whose value suddenly changes from the irreducible water saturation, S_{wi}, to the front saturation S_{f}. These discontinuities are due to the hyperbolic character of the saturation transport equation and they are described analytically in the case of the 1D displacement: it is the Buckley-Leverett theory that is described in detail in Charles-Michel Marle's work Les écoulements polyphasiques en milieu poreux. Seconde édition revue et augmentée 1972. Editions Technip, Paris.

Whatever the method selected, the pressure equation has to be regularly updated so as to estimate the velocities with precision.

Another class of techniques, more and more commonly used by operator companies, comprises the techniques referred to as streamline, one reference of which is: R. P. Batycky, M. J. Blunt, and M. R. Thiele, A 3d field-scale streamline-based reservoir simulator, SPERE, 11, 246-254 (1997).

In these methods, the saturations are updated by following the displacement of the fluids in their motion along the streamlines, parametrized curves defined by dx/dt=u(x,t). A variable change allows to return to the aforementioned Buckley-Leverett theory. However, in order to properly calculate velocity u(x,t), the pressure is solved as many times as required for accuracy reasons, on a Cartesian grid. These methods are faster than conventional methods. They do not have the versatility and the robustness for dealing with complex compositional problems where the conventional method remains the only possible solution. Costly pressure field updating cannot be avoided.

Finally, there are front tracking techniques (R Juanes a,d KA Lie “A front tracking method for efficient simulation of miscible gas injection.” paper SPE 92298, Houston 31 Jan. to 2 Feb. 2005) wherein the basic idea is to monitor the front by a Lagrangian approach that requires the same pressure updating. In this type of method, the description of multiphase flows in underground reservoirs consists in determining the position of the front (also referred to as interface) separating two immiscible fluids in motion: a fluid in place (oil for example) and a sweeping fluid (water for example), also called injected fluid.

The evolution of the front in the reservoir as it flows therethrough is considerably influenced by the coupling (referred to as viscous coupling by reservoir engineers) between the pressure field and the saturation field (Saffinan P. G. and G. Taylor. The penetration of a fluid into a porous medium or hele-shaw cell containing a more viscous liquid. Proc. Royal Society of London, A245:312-329, 1958, Noetinger B., V. Artus, and L. Ricard. Dynamics of the water-oil front for two-phase, immiscible flows in heterogeneous porous media. 2-isotropic media. Transport in porous media, 56:305-328, 2004).

In particular, when the injected fluid is less viscous and consequently more mobile at the front than the fluid in place, the viscous instabilities will always favour flow of the fluids in the most permeable layers of the medium. The breakthrough time through these layers is much faster than in the rest of the reservoir. On the other hand, if the injected fluid is less mobile, the viscous coupling can slow it down in the initially higher-velocity layers, thus compensating for the permeability differences due to the stratification. A stationary front then appears (Artus V., B. Noetinger, and L. Ricard. Dynamics of the water-oil front for two-phase, immiscible flows in heterogeneous porous media. 1-stratified media. Transport in Porous Media, 56:283-303, 2004).

It is well known that the front stability after small perturbations is determined by the fluid viscosity ratio. If the less viscous fluid is displaced by the more viscous fluid, then the front is stable, and vice versa. If the situation is unstable, phenomena referred to as “viscous fingers” develop in the course of time.

The effects of the relative permeability are taken into account by considering the Buckley-Leverett type displacements in a homogeneous medium. Such displacements are described by a hyperbolic saturation equation. One solution to this equation by means of the method of characteristics provides solutions that have oscillations characterized by a Rankine-Hugoniot condition. It has been shown that the stability of the front where the saturation has a “shock” is determined by a frontal mobility ratio, denoted by M_{f}: if M_{f}<1, then the front is stable in the face of small perturbations, and vice versa. This frontal mobility ratio can be related to the viscosity ratio using the relative permeability function.

More recently, this result was confirmed within the context of linearized stability analyses of the water injection process. In this context, it has been shown that the evolution of the Fourier transform of the front position fluctuations, the latter being denoted by δh(q, t), in a homogeneous medium is given by:

$${\partial }_{t} δ h ( q , t ) = {c}_{0} \vert q \vert \frac{{M}_{f} - 1}{{M}_{f} + 1} δ h ( q , t ) \qquad ( 14 )$$

where:

$${c}_{0} = \frac{{u}_{0}}{φ} \frac{{f}_{w} ( {S}_{f} ) - {f}_{w} ( {S}_{wr} )}{{S}_{f} - {S}_{wr}} = \frac{{u}_{0}}{φ} {f}_{w}^{′} ( {S}_{f} )$$

with:
M_{f}: the frontal mobility ratio
u₀: the mean filtration rate along the direction of axis X
φ: the porosity
f_{w}: the Buckley-Leverett function representing the fractional water flow
S_{f}: water saturation at the front
S_{wr}: maximum water saturation.

To sum up, all the aforementioned numerical techniques are costly in computing time, mainly because of the large number of solutions of large-size linear systems from the equation governing the pressure, that have to be updated by monitoring the displacement of the fluids with good precision.

Existing solutions do therefore not allow to obtain quantitative answers to practical questions that petroleum engineers consider when carrying out reservoir simulation studies, i.e.:

1. Fast sampling of the space of the study parameters that the modelling relates to, so as to optimize one or more economic and technical development criteria (development decision, selection of the position of the wells, of a recovery method, etc.).

2. Know how to coherently modify the geologic model in order to best calibrate the observed production data, including repeated seismic survey data. This can allow to drill while adapting to the geologic heterogeneities, to locate the fluids and therefore to better control the recovery scenario.

3. Be able to estimate uncertainties by carrying out Monte Carlo simulations so as to test the role of heterogeneities or of little-known parameters characterizing the subsoil. This allows to quantify the risk level linked with the development of a reservoir and thus to redefine development parameters, or even the economic parameters.

An exhaustive study including these various aspects (sensitivity study, data calibration and uncertainty estimation) can then potentially require repeated use of a flow simulator (dedicated software), hence the advantage of fast computing tools, of a precision compatible with that of the input data.

The method according to the invention allows to determine the position of a front separating two immiscible fluids in motion in a heterogeneous porous medium, without systematically updating the pressure field so as to obtain a simulation of the multiphase flows in the porous medium that is fast enough to obtain quantitative information allowing optimum development of the reservoir, by determining technical development parameters and/or economic parameters.

### SUMMARY OF THE INVENTION

The invention relates to a method of optimizing the development of a heterogeneous porous medium containing a fluid, referred to as fluid in place. Development is achieved by injecting into the medium a second fluid, referred to as sweeping fluid, to cause flow of the fluid in place. These two fluids are immiscible. According to the method, the medium is discretized into a grid consisting of a set of cells. The method comprises the following stages:

determining a velocity and a direction of flow for at least one of said fluids, using a flow simulator to solve a pressure equation,

defining a relation describing a position of a front separating said fluids, by freeing oneself from a viscous coupling by means of the perturbation theory, and by taking into account the velocity fluctuations in the front advance direction and the velocity fluctuations in the direction perpendicular to the front advance direction; and for different time intervals,

reconstructing the position of the front in said grid by means of a discretization of said relation and of a fast Fourier transform; and

optimizing the injection of said sweeping fluid according to the position of said front.

According to the method, the relation defined can notably comprise the following two terms:

a first term representing a viscous coupling describing the perturbation due to the saturation variation,

a second term describing the perturbations of the position of the front caused by the medium heterogeneities.

This first term can be obtained by considering the homogeneous medium and the front displacements of Buckley-Leverett type. The second term can be obtained using the fact that the front is a material surface and by representing the velocity as a sum of a mean velocity with velocity fluctuations due to the heterogeneities.

The first term can depend on at least the following parameters: a frontal mobility ratio, a mean filtration rate along a front advance direction, a porosity of the medium, a Buckley-Leverett function representing a fractional water flow, a water saturation at the front, a maximum water saturation, the wave vector in the Fourier space.

The second term can depend on at least the following parameters: a nonperturbed front velocity, a mean total velocity, perturbations of the components of the total velocity in the front advance direction and in the direction perpendicular thereto.

Finally, to optimize the injection, it is possible to determine at each cell and for different time intervals the saturation of at least one of said fluids from the position of said front.

### BRIEF DESCRIPTION OF THE FIGURES

Other features and advantages of the method according to the invention will be clear from reading the description hereafter of non limitative embodiment examples, with reference to the accompanying figures wherein:

FIGS. 1A and 1B show a comparison between the result provided by the method according to the invention (FIG. 1A) and a streamline-based simulation (FIG. 1B).

### DETAILED DESCRIPTION

The method according to the invention allows to optimize the development of a heterogeneous porous medium within the context of enhanced oil recovery (EOR) for example. This technique consists in injecting, into a petroleum reservoir, a sweeping fluid (CO₂, water) so as to cause flow of a fluid in place (oil), contained in the reservoir, that is to be extracted. These two fluids must of course be immiscible.

Within the context of enhanced recovery, we consider a situation where there is an interface, referred to as front, separating these two fluids. On the reservoir scale, the width of this front is small in relation to the size of the petroleum reservoir studied and, for simplicity reasons, this front is assumed to be narrow in relation to the size of the reservoir. The study is focused on the dynamics of this front in a heterogeneous porous medium, the capillary effects and gravity being disregarded.

The method according to the invention allows to optimize the injection by determining, for different times, referred to as time intervals, the position of the front separating the two fluids in motion in a heterogeneous porous medium (the reservoir for example). The method is based on an original technique of systematically updating the pressure field, which affords the advantage of being both precise and fast, insofar as the method requires only very limited use of a simulator carrying out long and complex calculations. Updating of the pressure field, due to the change in the front geometry, is therefore performed semi-analytically by means of fast Fourier transform techniques (FFT). Most of the calculating time due to this pressure field updating is thus saved, hence the rapidity of the method. The method mainly comprises the following stages:

discretizing the medium into a set of grid cells,

determining the velocity field for each one of the fluids,

defining a relation describing the position of the front in a heterogeneous medium, and at each time interval,

estimating the position of the front by means of the relation and of the velocities,

optimizing injection of the sweeping fluid according to the position of the front.

Discretization of the Medium

Discretization of the medium is a conventional stage known to specialists. It allows to represent the structure of the medium in a set of cells characterized by their dimensions and their geographic positions. Calculations are carried out for each cell. This stage is essential for using flow simulators (the simulator is a dedicated software). This set of cells is called “grid”. This grid discretizing the medium can be rectangular of size Lₓ×L_{y} cells.

Determination of a Heterogeneous Velocity Field

During this stage, a heterogeneous velocity field is determined within the context of a single-phase flow. The pressure equation (equations (6) and (7)) obtained by combining Darcy's law and the incompressibility equation is numerically solved by means of a single-phase flow simulator. The velocity vector of each fluid, i.e. the velocity and the direction of flow thereof, is thus determined at a time t=0.

For a 2D domain (the 3D case is dealt with in exactly the same way) of size Lₓ×L_{y} whose permeability map is K(x, y) and for which the main flow is parallel to an axis X, y representing the transverse co-ordinate (on axis Y), solution of the pressure equation consists in solving the equation as follows:

∇.(λ(S_{w}(x,y,t=0).∇P(x,y))=0

We thus deduce from these equations the total velocity field u:u_{nw}, the velocity vector of the nonwetting fluid, and u_{w}, the velocity vector of the wetting fluid.

This solution, which requires a simulator, is carried out only once according to the method. The pressure equation is solved in the beginning, i.e. for t=0, it is no longer solved in the next time intervals (t>0).

A standard five-point finite-volume type discretization can be used to solve this equation by means of the simulator: the pressure is estimated at the centre of the cells, the flows between cells involving calculated transmissivities by working out the harmonic means of the permeabilities of the two cells. Darcy's law then allows to determine the flows and the velocities.

The permeability map K(x,y) can be generated by means of a random field generator, as described in the following document for example:

Le Ravalec, M., Noetinger, B., and Hu, L. Y. [2000] The FFT moving average (FFT-MA) generator: An efficient numerical method for generating and conditioning Gaussian simulations. Mathematical Geology 32(6), 701-723.

Definition of a Relation Describing the Position of the Front in a Heterogeneous Medium

The basic idea thus consists in avoiding recalculating at each time iteration the flow in the entire calculation domain, by limiting oneself to the description of the motion of the front, described by function δh(y, t). This is possible by means of an approximation allowing to relate the modification of the pressure field δp(x, y, t), and therefore of the velocities, to the distortion of the front δh(y, t). The pressure can thus be eliminated from the problem and we then have to solve a differential system involving δh(y, t).

We have seen that, in a homogeneous medium, the evolution of the Fourier transform of the front position fluctuations, denoted by δh(q, t), is given by:

$${\partial }_{t} δ h ( q , t ) = {c}_{0} \vert q \vert \frac{{M}_{f} - 1}{{M}_{f} + 1} δ h ( q , t ) \qquad ( 14 )$$

where:

$${c}_{0} = \frac{{u}_{0}}{φ} \frac{{f}_{w} ( {S}_{f} ) - {f}_{w} ( {S}_{wr} )}{{S}_{f} - {S}_{wr}} = \frac{{u}_{0}}{φ} {f}_{w}^{′} ( {S}_{f} )$$

with:
M_{f}: the frontal mobility ratio
u₀: the mean filtration rate in the direction of axis x
φ: the porosity
f_{w}: the Buckley-Leverett function representing the fractional water flow
S_{f}: water saturation at the front
S_{wr}: maximum water saturation
q: wave vector in the Fourier space

In a heterogeneous medium, the problem is more complex. The permeability field heterogeneities initiate perturbations of the front, i.e. the front is deformed according to the strata permeability. Thus, these perturbations can increase or decrease according to the viscosity ratio. This is the problem of viscous coupling. The problem is nonlinear and a mathematical analysis is very complicated.

According to the invention, the heterogeneities are taken into account, on the one hand, by freeing oneself from the viscous coupling by means of the perturbation theory and, on the other hand, by taking account of the transverse velocity fluctuations, i.e. the fluctuations in an axis Y perpendicular to front advance axis X.

Decoupling by Means of the Perturbation Technique

The method according to the invention estimates the coupling between the velocity perturbations δu and the fluctuation of the front position δh in a semi-analytical way. In this sense, the method uses the perturbation theory.

From a heuristic point of view, the perturbation theory is a general mathematical method that allows to find an approximate solution to a mathematical equation (E_{λ}) depending on a parameter λ when the solution to equation (E₀), corresponding to value λ=0, is exactly known. Mathematical equation (E_{λ}) can be an algebraic equation, a differential equation, an eigenvalue equation, . . . The method consists in seeking the approximate solution to equation (E_{λ}) in form of a series expansion of the powers of parameter λ, this approximate solution being assumed to be an approximation of the exact but unknown solution that is all the better as the absolute value of parameter λ is “smaller”.

Thus, according to the invention, the perturbation theory leads to locally consider the velocity perturbation as the sum of two perturbations:

δu(x,y,t)=δuₐ(x,y,t)+δu_{b}(x,y,t) (15)

The first term, δuₐ, describes the perturbation due to the saturation variation, and the second term, δu_{b}, describes the perturbation due to the heterogeneity of the medium.

According to this expansion, we can describe the position of the front as it progresses in a heterogeneous porous medium by the equation as follows:

$${\partial }_{t} δ h ( q , t ) = {c}_{0} A \vert q \vert δ h ( q , t ) + \frac{{c}_{0}}{{u}_{0}} δ {u}_{bx} ( {x}_{f} , q , t ) \qquad ( 16 )$$

with:

$$A = \frac{{M}_{f} - 1}{{M}_{f} + 1}$$

δu_{bx}: the fluctuations of the filtration rate in the front advance direction (axis X)
x_{f}: the abscissa of the front position on axis X.

Thus, by means of this formulation of the front position, it is possible to decouple the problem. For small-variance permeability fields, the stability of the front undergoing small perturbations is therefore determined by the frontal mobility ratio.

Taking Account of the Transverse Velocity Fluctuations

According to the invention, the front propagation in a heterogeneous medium, i.e. in a heterogeneous velocity field, is simulated by modelling the influence of the viscous effects analytically. The heterogeneous velocity field was obtained using a single-phase flow simulation (stage 2 of the method).

To simplify the explanations, we take two dimensions. The front separating the two immiscible fluids is then described by a 2D function, x(y, t)=h(y, t). This equation can then be written in the form as follows:

F(x,y,t)=0 (17)

By solving it in relation to x, we have:

F₁(x,y,t)=h(y,t)−x=0 (18)

Then, using the fact that the surface in question is material, i.e. made up of fluid elements that follow the local motion of the fluid, and using the expression for the front propagation velocity for Buckley-Leverett type displacements, we obtain:

∂ₜh(y,t)=c₀(u·∇φ)|_{φ=0} (19)

Considering now the heterogeneity of the velocity field, we represent the velocity as a sum of two terms. The first one represents the mean and the second the fluctuations due to the heterogeneities:

u(r)=u₀+δu(r)

with: r={x,y}, u₀={u₀,0} and δu={δuₓ,δu_{y}}.

The velocity field perturbations cause front perturbations h(y,t)=h₀(t)+δh(y,t). By substituting this expansion in equation (19) and by extracting the mean term using relation δₜh₀(t)=c₀, which is valid for Buckley-Leverett type displacements, we obtain the following equation describing the front position perturbations caused by the medium heterogeneities:

$${\partial }_{t} δ h ( y , t ) = \frac{{c}_{0}}{{u}_{0}} ( δ {u}_{x} ( {x}_{f} , y ) - δ {u}_{y} ( {x}_{f} , y ) {\partial }_{y} δ h ( y , t ) ) \qquad ( 20 )$$

Thus, by applying the perturbation theory, the material surface theory, and using the expression of the front propagation velocity for Buckley-Leverett type displacements, the position of the front in a heterogeneous porous medium can be described as follows (δh was substituted for h in this expression for clarity reasons):

$${\partial }_{t} h ( y , t ) = {c}_{0} A \int \frac{d q}{2 π} \vert q \vert h ( q , t ) {e}^{i qy} + \frac{{c}_{0}}{{u}_{0}} ( δ {u}_{x} ( {x}_{f} , y ) - δ {u}_{y} ( {x}_{f} , y ) {\partial }_{y} h ( y , t ) ) \qquad ( 21 )$$

The first term (left) is the expression of the viscous coupling and it can be advantageously calculated in the Fourier space. It is therefore no longer necessary to estimate this coupling through a costly linear system solution. In the description hereafter, the velocity perturbations δuₓ and δu_{y} can now be assumed to be decoupled from the saturation equation. The second term (right) is obtained by means of a single-phase flow simulator (stage 2 of the invention).

The next stage of the method consists in providing a complete front equation solution technique.

Front Position Estimation

A heterogeneous velocity field in the context of a single-phase flow was established in stage 2 of the method according to the invention by numerical solution (by means of a single-phase flow simulator) of the pressure equation.

Then, equation (21) is discretized on the grid discretizing the medium. This discretized equation is then used to obtain the front perturbations for each time interval. An explicit numerical scheme described hereafter is then used.

Subscript i is introduced to number the cells in the direction of axis X, subscript j to number the cells along axis Y, and n to number the time intervals. Δx designates the size of a cell in direction X, Δy the size of a cell in direction Y, and Δt the time interval.

The method of solving discretized equation (21) is as follows:

1—A fast Fourier transform is first performed for the front perturbations. In fact, the approximation by a perturbation series expansion has a simple explicit formulation in the Fourier space. Thus, according to the method, the calculation is carried out in the domain where it is the simplest since the cost of a fast Fourier transform (FFT) is considered to be negligible. A fast Fourier transform (FFT) algorithm at y allows the first member of equation (21) to be rapidly estimated:

$$δ {h}_{k}^{n} = {\sum }_{j = 1}^{{N}_{y}} δ {h}_{j}^{n} exp ( - \frac{2 π i ( k - 1 ) ( n - 1 )}{{N}_{y}} ) \qquad ( 22 )$$

2—Then the Fourier modes of the front position fluctuations are multiplied by a modulus of the wave vector in the Fourier space, and an inverse Fourier transform is used to return to the real space. The central difference, well known to specialists, is used to obtain an approximation of the velocity derivative along y. We thus obtain the following explicit scheme:

$$\begin{matrix}δ {h}_{j}^{n + 1} = δ {h}_{j}^{n} + {c}_{0} A Δ t \frac{1}{{N}_{y}} {\sum }_{k = 1}^{{N}_{y}} \frac{2 π ( k - 1 )}{{N}_{y} Δ y} δ {h}_{k}^{n} exp ( \frac{2 π i ( k - 1 ) ( n - 1 )}{{N}_{y}} ) + \\ \frac{{c}_{0}}{{u}_{0}} Δ t ( δ {u}_{i , j}^{n} - δ {v}_{i , j}^{n} \frac{δ {h}_{j + 1}^{n} - δ {h}_{j - 1}^{n}}{2 Δ y} ) \\ δ {h}_{k}^{n} = {\sum }_{j = 1}^{{N}_{y}} δ {h}_{j}^{n} exp ( - \frac{2 π i ( k - 1 ) ( n - 1 )}{{N}_{y}} )\end{matrix} \qquad ( 23 )$$

where subscript i is defined by the position of the front in the previous time interval n. Here, term δh_{i,k}ⁿ represents the Fourier transform of the front at frequency k, δu represents the longitudinal velocity fluctuation along axis X (δuₓ), and δv represents the longitudinal velocity fluctuation along axis Y (δu_{y}). The discrete Fourier transform and its inverse can be implemented using a fast Fourier transform (FFT) algorithm to speed up the calculations.

After calculating the front fluctuations for a given time interval Nₜ, the position of the front is reconstructed in the medium discretization grid by means of the following formula:

hⱼ^{N}^{ₜ}=ΔtNₜc₀+δhⱼ^{N}^{ₜ} (24)

It can be reminded that the approximation of velocity u was made once and for all, since the viscous coupling is modelled via the convolution term (first term of equation (21)).

The position of the front can thus be determined explicitly for each time interval after determining only once, at the time t=0, the velocities of the fluids by solving the pressure equation by means of a flow simulator.

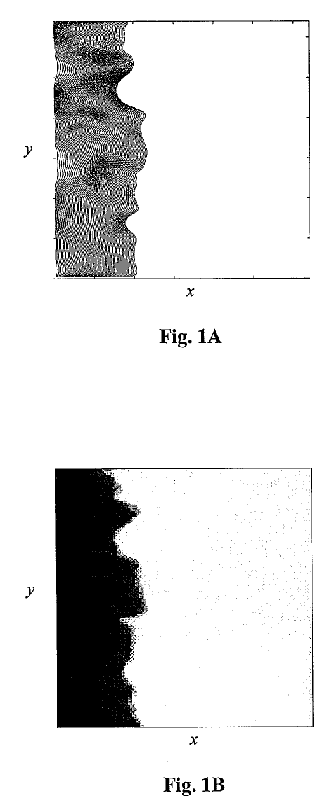

It can be noted that the technique provided requires only one complete numerical solution of the pressure equation, unlike techniques that require as many such solutions as there are time intervals. A comparison between the method according to the invention (FIG. 1A) and a simulation using a market streamline-based simulator (FIG. 1B) illustrates that, despite the approximation made to save calculating time, the result accuracy remains comparable to the other methods. FIG. 1A shows the front of the interface simulated with the method, whereas FIG. 1B shows the front of the interface simulated by means of a market streamline-based simulator. These figures show a cross-sectional view of the subsoil, the abscissa axis corresponds to a horizontal geographic co-ordinate x, whereas the ordinate axis represents depth y.

Optimization of Oil Recovery by Injection

From the position of the front, it is known to determine the saturations at each cell of the medium and for each time interval. It is possible to use for example the current tube method (well known to specialists) far from the front, and to interpolate the saturations near to the front, whose position is now well determined.

The time when and the point where the fluid injected to facilitate recovery will reach the well can be determined by monitoring the geographic and temporal evolution of the saturations. When water is used to “push” the oil in place in a reservoir, knowing these saturations allows to determine the breakthrough time of the water, which is a key datum in oilfield development.

Through fast determination of the saturations, the man skilled in the art can:

1—Rapidly sample the space of the study parameters that the modelling relates to, so as to optimize one or more economic development criteria (development decision, selection of the position of the wells, of a recovery method, etc.).

2—Coherently modify the geologic model in order to best calibrate the observed production data, including repeated seismic survey data. This can allow to drill while adapting to the geologic heterogeneities, to locate the fluids and therefore to better control the recovery scenario.

3—Estimate uncertainties by carrying out Monte Carlo simulations so as to test the role of heterogeneities or of little-known parameters characterizing the subsoil. This allows to quantify the risk level linked with the development of a reservoir and thus to redefine development parameters, or even the economic parameters.

An exhaustive study including these various aspects (sensitivity study, data calibration and uncertainty estimation) potentially requires repeated use of a flow simulator (dedicated software). Existing solutions do therefore not allow to obtain quantitative answers to practical questions that petroleum engineers consider when carrying out reservoir simulation studies, hence the advantage of the method according to the invention that provides a fast computing tool, of a precision compatible with that of the input data.

The following notations are used in the description of the invention:

u_{nw}: Nonwetting fluid velocity vector
u_{w}: Wetting fluid velocity vector
u: Total velocity of the fluids
λ_{nw}: Nonwetting fluid mobility
λ_{w}: Wetting fluid mobility
p_{nw}: Nonwetting fluid pressure
p_{w}: Wetting fluid pressure

### K: Absolute permeability tensor of the medium

k_{rnw}: Relative permeability of the nonwetting fluid
k_{rw}: Relative permeability of the wetting fluid
μnw: Nonwetting fluid viscosity
μ_{w}: Wetting fluid viscosity
p_{c}(S): Capillary pressure

### S_{nw}: Nonwetting fluid saturation

### S_{w}: Wetting fluid saturation

p: Common pressure of the two fluids, if p_{c}(S)=0

### φ: Porosity (assumed to be uniform in the reservoir)

t: Time

### S_{wi}: Irreducible water saturation

### S_{f}: Water saturation at the front

### M_{f}: Total mobility ratio at the front

q: Wave vector in the Fourier space
c₀: Velocity of the nonperturbed front
u₀: Reference constant velocity

### S_{wr}: Maximum water saturation

f_{w}′: Derivative of the fractional water flow
h₀: Reference front position
h(y, t): Front position
δh(y, t): Front position fluctuation
n: Normal vector at the front
u₀: Mean total velocity
δu_{nw}: Perturbation of the nonwetting fluid velocity vector
δu_{w}: Perturbation of the wetting fluid velocity vector
δu: Perturbation of the total velocity vector of the fluids
δuₓ: Perturbation of component x of the total velocity
δu_{y}: Perturbation of component y of the total velocity

### F: Front equation

### F₁: Front equation in canonical form

### Lₓ, L_{y}: Size in x and y of the domain

### Vₙ: Normal velocity at the front

f(S): Fractional water flow

### A₁: Injection area

### Q: Total injected flow rate

### V: Volume of the porous medium

x: Longitudinal co-ordinate
y: Transverse co-ordinate
k: Discretized wave vector
t_{D}: Nondimensional time by the mean breakthrough time 19,50

1. A method of optimizing recovery of a fluid in place in a heterogeneous porous medium, by injecting into the medium a sweeping fluid to cause flow of the fluid in place, the fluids being immiscible, wherein the medium is discretized into a grid of a set of cells, the method comprising:
determining a velocity and a direction of flow for at least one of the fluids, using a flow simulator to solve a pressure equation;
defining a relation describing a position of a front separating the fluids, without a viscous coupling by a perturbation theory, and by accounting for velocity fluctuations in a front advance direction and velocity fluctuations in a direction perpendicular to the front advance direction; and
for different time intervals, reconstructing a position of the front in said the grid by means of a discretization of the relation and of a fast Fourier transform; and optimizing the injection of the sweeping fluid according to the position of the front.

2. A method as claimed in claim 1, wherein the relation comprises a first term representing a viscous coupling describing a perturbation due to a saturation variation, and a second term describing front position perturbations caused by heterogeneities of the medium.

3. A method as claimed in claim 2, wherein the first term is obtained by considering a homogeneous medium and Buckley-Leverett displacements of the front.

4. A method as claimed in claim 2, wherein the second term is obtained by considering the front to be a material surface, and by representing the velocity as a sum of a mean velocity with velocity fluctuations due to the heterogeneities of the medium.

5. A method as claimed in claim 3, wherein the first term depends on at least the following parameters: a frontal mobility ratio, a mean filtration rate along a front advance direction, a porosity of the medium, a Buckley-Leverett function representing a fractional water flow, a water saturation at the front, a maximum water saturation, and a wave vector in Fourier space.

6. A method as claimed in claim 4, wherein the second term depends on at least the following parameters: a nonperturbed front velocity, a mean total velocity, perturbations of the components of the total velocity in the front advance direction and in a direction perpendicular thereto.

7. A method as claimed in claim 1, wherein injection is optimized by determining at each cell and for different time intervals a saturation of at least one of the fluids from a position of the front.

8. A method as claimed in claim 2, wherein the relation comprises a first term representing a viscous coupling describing a perturbation due to a saturation variation, and a second term describing front position perturbations caused by heterogeneities of the medium.

9. A method as claimed in claim 3, wherein the relation comprises a first term representing a viscous coupling describing a perturbation due to a saturation variation, and a second term describing front position perturbations caused by heterogeneities of the medium.

10. A method as claimed in claim 4, wherein the relation comprises a first term representing a viscous coupling describing a perturbation due to a saturation variation, and a second term describing front position perturbations caused by heterogeneities of the medium.

11. A method as claimed in claim 5, wherein the relation comprises a first term representing a viscous coupling describing a perturbation due to a saturation variation, and a second term describing front position perturbations caused by heterogeneities of the medium.

12. A method as claimed in claim 6, wherein the relation comprises a first term representing a viscous coupling describing a perturbation due to a saturation variation, and a second term describing front position perturbations caused by heterogeneities of the medium.

13. A method as claimed in claim 9, wherein the first term depends on at least the following parameters: a frontal mobility ratio, a mean filtration rate along a front advance direction, a porosity of the medium, a Buckley-Leverett function representing a fractional water flow, a water saturation at the front, a maximum water saturation, and a wave vector in Fourier space.
